(19) United States
(12) Patent Application Publication
(10) Pub. No.: US 2013/0054327 A1
(43) Pub. Date: Feb. 28, 2013

(54) REDEMPTION OF REWARDS POINTS FOR USE WITH PRODUCTS AND SERVICES

(71) Applicants: Erik Stephen Ross, Charlotte, NC (US); Scott Anthony Thayer, Cornelius, NC (US); Leonard Marc Nathan, Wilmington, DE (US); Alexander Azariy Shenkar, Roswell, GA (US); Xixi Yin, Phoenix, AZ (US); James A. Greco, Elkton, MD (US)

(72) Inventors: Erik Stephen Ross, Charlotte, NC (US); Scott Anthony Thayer, Cornelius, NC (US); Leonard Marc Nathan, Wilmington, DE (US); Alexander Azariy Shenkar, Roswell, GA (US); Xixi Yin, Phoenix, AZ (US); James A. Greco, Elkton, MD (US)

(73) Assignee: BANK OF AMERICA, Charlotte, NC (US)

(21) Appl. No.: 13/219,180

(22) Filed: Aug. 26, 2011

(51) Int. Cl. G06Q 30/00

(52) U.S. Cl. 705/14.17

(57) ABSTRACT

Apparatuses, computer readable media, methods, and systems are described for determining a first amount of points associated with an account, providing an offer comprising a financial term and a second amount of points required to adjust the financial term, and causing execution of a transaction to execute the offer for the adjusted financial term in response to determining that the first amount of points equals or exceeds the second amount of points.

### BACKGROUND

A credit card issuer, such as a bank or credit union, may approve an account for a customer and issue a credit card to the customer. Customers may make purchases at retailers or other merchants accepting that card. When a purchase is made, the customer agrees to pay the card issuer for the amount charged. Merchants may use electronic verification systems to confirm that the card is valid and that the customer has sufficient credit. Each month, the issuer may send the customer a statement listing the purchases made with the card, and the amount owed. The customer may pay a minimum amount up to the entire balance by a due date. Interest may be assessed on the amount owed if not paid in full.

Credit card companies often provide incentives for their customers to continue using a credit card, for balance transfers and/or for cash advances. Incentives can include rewards such as frequent flyer points, gift certificates, or cash back. Credit card companies earn fees on each transaction with a retailer or other type of merchant, and may use a portion of these fees to provide the incentives. A credit card company may provide a product or cash reward when a customer has made purchases using the card.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

According to aspects of example embodiments, apparatuses, computer readable media, methods, and systems are described for determining a first amount of points associated with an account, providing an offer comprising a financial term and a second amount of points required to adjust the financial term, and causing execution of a transaction to execute the offer for the adjusted financial term in response to determining that the first amount of points equals or exceeds the second amount of points.

Aspects of the embodiments may be provided in at least one computer-readable medium and/or memory storing computer-executable instructions that, when executed by at least one processor, cause a computer or other apparatus to perform one or more of the process steps described herein.

These and other aspects of the embodiments are discussed in greater detail throughout this disclosure, including the accompanying drawings.

### BRIEF DESCRIPTION OF THE DRAWINGS

The present disclosure is illustrated by way of example and not limited in the accompanying figures in which like reference numerals indicate similar elements and in which:

FIG. 1 shows an illustrative operating environment in which various aspects of the disclosures may be implemented in accordance with example embodiments.

FIG. 2 is an illustrative block diagram of workstations and servers that may be used to implement the processes and functions of certain aspects of the present disclosure in accordance with example embodiments.

FIG. 3 illustrates an example offers graphical user interface (GUI) presented by a customer terminal to recommend offers for financial products/services in accordance with example embodiments.

FIG. 4 illustrates an example savings GUI presenting potential savings and/or benefits to a customer in accordance with example embodiments.

FIG. 5 illustrates a payment GUI for an account where a customer may use points to pay a fee in accordance with example embodiments.

FIG. 6 illustrates an example points solicitation GUI to help a member of a social network group to attain a goal for personal or charitable causes in accordance with example embodiments.

FIG. 7 illustrates an example flow diagram of a method for executing a transaction for an account having an adjusted financial term in exchange for points in accordance with example embodiments.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope and spirit of the present disclosure.

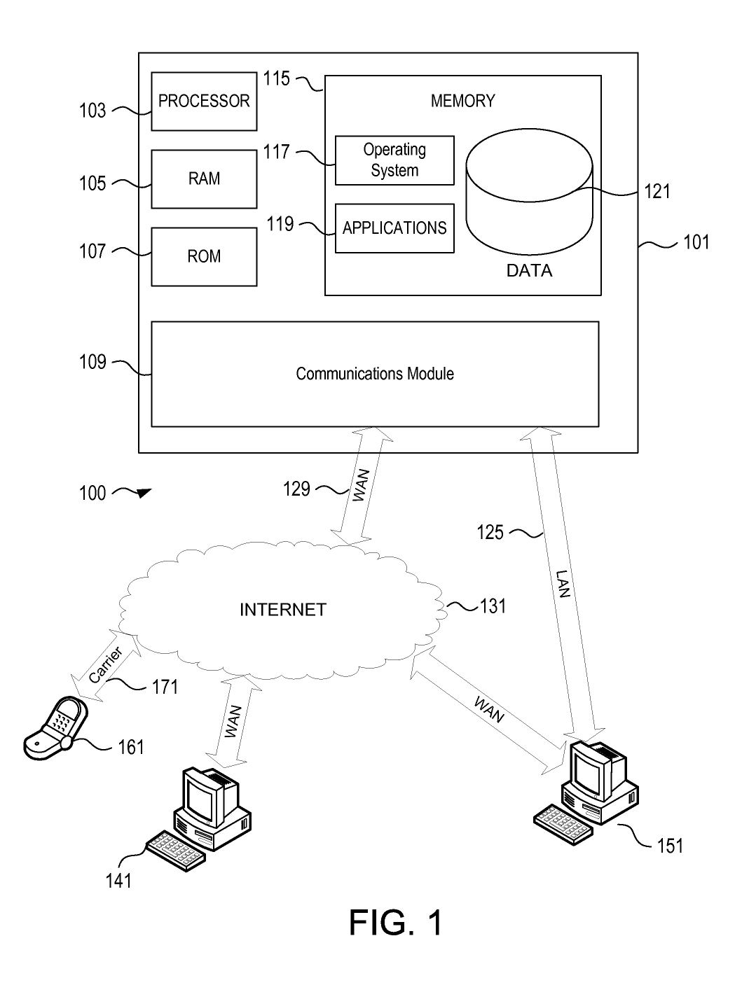

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including random-access memory (RAM) 105, read-only memory (ROM) 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more are applications representing the application data stored in RAM 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Also, some or all of the computer executable instructions for computing device 101 may be embodied in hardware or firmware.

Computing device 101 may operate in a networked environment supporting connections to one or more remote computing devices, such as computing devices 141, 151, and 161. The computing devices 141, 151, and 161 may be personal computing devices or servers that include many or all of the elements described above relative to the computing device 101. Computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 may be connected to the LAN 825 through a network interface or adapter in the communications module 109. When used in a WAN networking environment, the computing device 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server configuration to permit a user to retrieve web pages from a web-based server. Any of various conventional web browsers can be used to display and manipulate data on web pages.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the disclosure may include forms of computer-readable media. Computer-readable media include any available media that can be accessed by a computing device 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on a computing device 101. Such a processor may execute computer-executable instructions stored on a computer-readable medium.

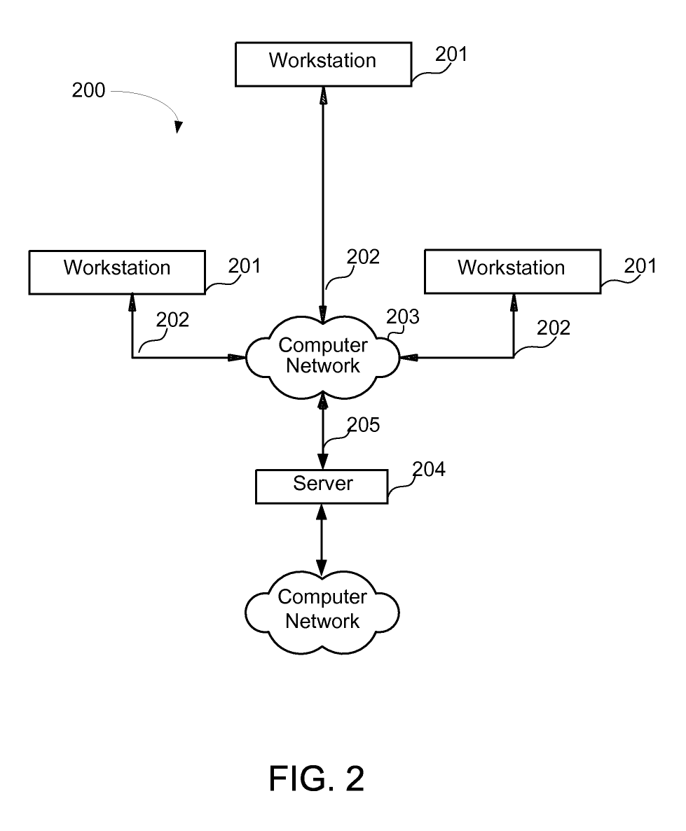

Referring to FIG. 2, an illustrative system 200 for implementing example embodiments according to the present disclosure is shown. As illustrated, system 200 may include one or more workstation computers 201. Workstations 201 may be local or remote, and may be connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

Conventional rewards systems have been limited to providing a user with a product or cash in exchange for points. The example embodiments provide a novel rewards system permitting a customer to redeem rewards points to adjust a financial term of a financial product or service.

In an example and with reference to FIG. 1, a computing device 101 (hereinafter server 101) may be associated with a financial institution, such as a bank or other entity. One or more customers may have a financial account (e.g., credit card account, mortgage, brokerage, etc.) or other financial product and/or service with the financial institution. To incentivize the customer to continue using the financial account, the financial institution may offer rewards points or other incentives to the customer. For example, the customer may pay with a credit card at a retailer, and a computer of the retailer may communicate with the server 101 to authorize the transaction. The server 101 may award rewards points to the customer based on, for example, the amount of the transaction and/or a type of product purchased. Rewards points may also be given for on-time payments, opening one or more other accounts, shopping at particular merchants, other desirable customer behaviors, and/or any combination thereof. The server 101 may include a database or other memory for storing an amount of rewards points accrued by each customer. To facilitate interaction with customers, the server 101 may include a web server for serving a website or other electronic graphical user interface to a computing device 151 of a customer (hereinafter customer terminal 151) via the network 131.

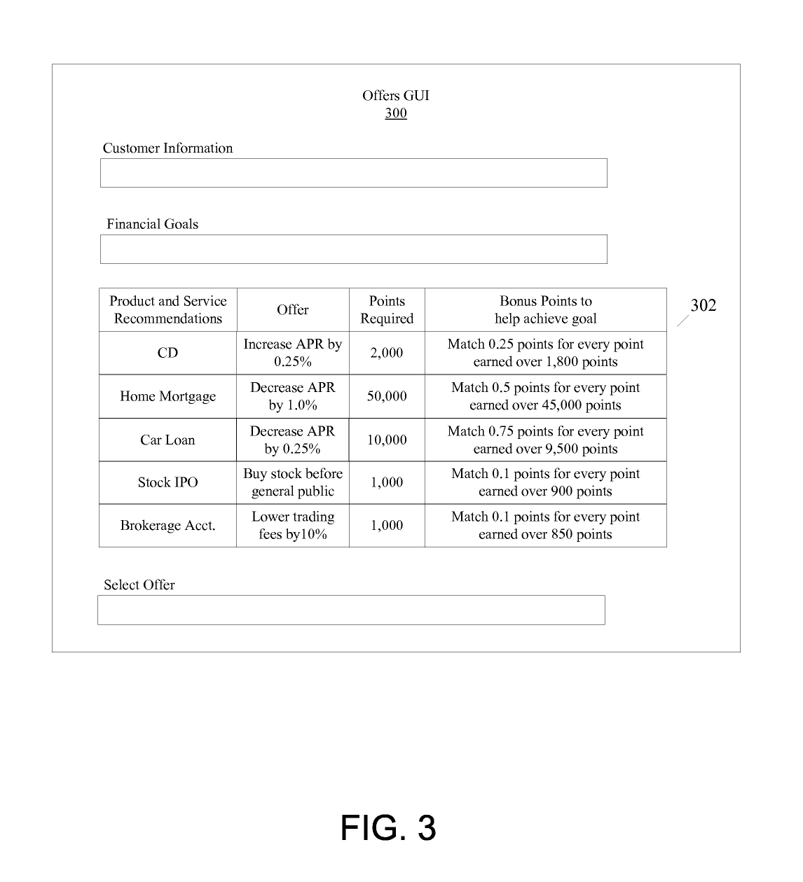

FIG. 3 illustrates an example offers graphical user interface (GUI) presented by the customer terminal 151 to recommend offers for financial products/services to a customer. Each offer communicated to the customer may identify a financial term that can be adjusted in exchange for rewards points. The server 101 may communicate an offer message to the customer terminal 151 for presentation in the offer table 302 of the offers GUI 300.

If the customer is a new customer, the offers GUI 300 may include a field permitting the new customer to sign up for a financial product and/or service (e.g., credit card account). The new customer may input their personal information (e.g., name, address, phone number, social security number, etc.). For an existing customer, the offers GUI 300 may prompt the customer to provide authentication information (e.g., username and password).

The offer table 302 may list offers of recommended financial products and/or services for a customer, and an amount of rewards points required to redeem each offer. Each offer may include a financial term that can be adjusted in exchange for a predetermined number of rewards points. For example, the offer table 302 may present a recommended certificate of deposit (CD) and may offer to increase an annual percentage rate by a predetermined amount (e.g., 0.25% APR) in exchange for 2,000 rewards points. In another example, the offer table 302 may present a recommended home mortgage and may offer to decrease the annual percentage rate by a predetermined amount (e.g., 1.0% APR) in exchange for 50,000 rewards points. In another example, an offer may permit a customer to buy stock in an initial public offering before the general public. In a further example, an offer may be to lower trading fees by a certain amount (e.g., 10%) on a brokerage account.

If a customer does not have sufficient rewards points for an offer, the financial institution may assist the customer in accruing the needed number of rewards points to accept the offer. For example, the offers in table 302 may be associated with a multiplier or other manner of awarding additional rewards points to the customer upon meeting certain conditions. The server 101 may award bonus rewards points to the customer upon reaching a certain points level (e.g., predetermined percentage of amount of needed points or threshold points level) towards a financial goal to help more quickly achieve the goal. For example, the financial institution may award 1 reward point for every dollar spent. If the customer indicates a desire to lower an APR rate for a mortgage by 1% and to do so would require redemption of 50,000 rewards points, the financial institution may agree to award a bonus of 0.25 additional rewards points to the customer for every dollar spent when reaching 45,000 rewards points. The server 101 may restrict use of the bonus rewards points only for redeeming a particular offer previously denoted by the customer, may limit their use to a certain time frame, or may not provide any restrictions on the bonus rewards points. To obtain the bonus points, the customer may have to sign up for a particular offer. For example, the customer may select a desired offer from the offer table 302, thereby causing the customer terminal 151 to communicate a desired offer message to the server 101. Thereafter, the server 101 may track rewards points accrued by the customer and award bonus rewards points when the customer meets the conditions for obtaining the bonus rewards points.

The offers GUI 300 may also prompt the new customer to input information about the customer's financial goals to tailor which offers are included in the offer table 302. Example financial goals may be to purchase a home, to open a CD, to obtain a car loan, to open a brokerage account, etc. The customer terminal 151 may communicate the input information to the server 101 for processing.

To populate the offer table 302, the server 101 may store a listing of available offers for financial products/services currently being offered by the financial institution, and may associate each offer with a financial term that can be varied in exchange for rewards points. Example financial terms may include an annual percentage rate, a fee (e.g., an overdraft fee, an early withdrawal penalty for a CD, etc.), and an interest rate, as well as other types of financial terms. Offers may also include discounts from commercial or corporate bank partners (e.g., Starbucks®, Target®, Best Buy®, etc.). In some examples, an offer may limit a duration of the change to the financial term and may require the customer to meet one or more addition conditions to maintain the changed financial term. For example, the offer may require that the customer spend a certain amount within a certain time period to maintain the changed financial term.

The server 101 may filter the listing of available offers to identify one or more offers that are relevant to the customer, such as based on the customer's financial goals. Each offer may be an offer to adjust a financial term of an existing account the customer already has with the financial institution, and/or may be an offer for opening a new account. The server 101 may identify relevant offers based on a user's stated financial goals (e.g., earn more interest in a CD), a profile of the customer, and/or recent customer transactions (e.g., purchases within a predetermined time period). For example, an offer presented may be based on historical account activity, such as a financial institution offering a discounted rate for a next year based on a customer's previous year's spend/points earned.

The server 101 may generate a customer profile based on data supplied by the customer indicating his or her financial goals, demographic data, and, if the customer is an existing customer, previous transactions with one or more accounts maintained by the financial institution. Demographic data may classify a customer into one of multiple customer categories based on income, geographic location, age, shopping patterns, merchants, and other demographic information to identify similarly situated customers. For each customer category, the server 101 may determine which products and/or services are most commonly obtained by customers in that category. For instance, the server 101 may determine that most customers in a particular category (e.g., above a threshold percentage of the customers in a category) have a mortgage, a credit card account, and a car loan. The server 101 may also determine that the customer only has two of these three with the financial institution, and may identify an offer for the missing financial service/product. For existing customers, the server 101 may also indicate in the customer profile which financial products/services have been previously obtained by the customer, such as product/services obtained by the customer from a competing financial institution.

The server 101 may determine which offers for financial products/services to include in the offer table 302 based on the customer profile. Using the profile, the server 101 may identify offers for one or more financial products/services (1) that other customers in the same category have, but the customer does not; (2) that the customer is currently obtaining from a competitor; (3) for which the customer already has an account with the financial institution; (4) for which there is a current marketing campaign; and (5) similar to those being offered by a competitor, but at a discounted rate. For example, the marketing campaign may be associated with an opportunity to accrue additional rewards points (e.g., open another account with financial institution and receive bonus rewards points).

Additionally, the server 101 may determine which offers to include in the offer table 302 based on an average rate of rewards points earned per time interval (e.g., average number of points earned per month over the past six months). Based on the average, the server 101 may identify offers for which the customer does not quite have enough rewards points to redeem, but potentially may have in a certain time frame if they do not use the rewards points for something else. Example time frames may be over the next month, three months, six months, year, or any desired time frame. The server 101 may also exclude offers based on the average rate of rewards points if the customer would be unlikely to accrue sufficient rewards points in a predetermined amount of time.

The server 101 may prioritize the offers presented in the offer table 302 based on one or more priority factors, as well as on a weighted combination of multiple priority factors. An offer having the highest priority may be included at a top (or other highly visible location) of the offer table 302, and the remaining offers may be included in descending priority therebeneath (or in other less visible locations). The priority factors may correspond to a weighting assigned to one or more of financial products/services identified by the customer as being of interest, financial products/services purchased by other customers in the same customer category, financial products/services associated with competing financial products/services currently purchased by the customer, an amount of potential savings to the customer for an offer, an ability to accrue additional rewards points (e.g., open another account with financial institution and receive bonus rewards points), and/or any combination thereof.

In an example embodiment, each priority factor may be associated with a number, and the priority factors may be summed to determine a score. The server 101 may determine scores for each of the offers, and may order the offers in the offer table 302 based on descending numerical order of the scores. For example, financial products/services identified by the customer as being of interest may be assigned a number 5, financial products/services purchased by other customers in the same customer category may be assigned a number 4, financial products/services associated with competing financial products/services currently purchased by the customer may be assigned a number 3, and so forth. If a customer profile indicates that a customer has expressed interest in obtaining a mortgage and most other customers in the same category have a mortgage, then the server 101 may determine a score of 9 for a mortgage offer (i.e., sum of numbers associated with priority factors 5+4=9). The server 101 may determine scores for other offers, and may order the offers in the offer table 302 based on a descending numerical order of their scores.

The server 101 may process historical customer offer acceptance trends to adjust the numbers associated with each priority factor, as well as historical trends for other customers in the same customer category. For example, the server 101 may increase a number assigned to a priority factor where a customer previously obtained similar products/services from a competitor, due to the customer responding to an earlier offer. The server 101 may decrease numbers assigned to priority factors where a customer has not responded to associated offers in the past. The server 101 may make similar adjustments to priority factors based on historical trends of activity from other customers in the same customer category.

The server 101 may also rank offers based on the amount of potential savings to the customer. For example, a customer may have 20,000 rewards points that is enough either to reduce the APR on a credit card account or to reduce the APR on a customer's home mortgage, but not both. For a customer having a credit card account, the server 101 may calculate an average balance of the customer over a predetermined time period (e.g., previous 3 months, 6 months, etc.), and how much interest the customer paid. The server 101 may compare the credit card interest to the amount of interest the customer paid on their mortgage over the same time period. The server 101 may also estimate the amount of mortgage interest paid in view of a mortgage tax deduction, if applicable. Considering the reduced APR for each, the server 101 may rank the offers based on which would provide a greater savings to the customer. Each offer may indicate an expected amount of savings considering historical customer activity. Offers may also be ranked based on the amount of savings per rewards point redeemed. The server 101 may include the offers in the offer table 302 to correspond with the rankings. The highest ranked offer may be positioned at a top of the offer table 302 (or other preferred location) and the remaining offers may be positioned underneath in descending order (or other less preferred locations) based on their ranking.

From the table 302, the customer may, using an input device of the customer terminal 151, select a desired offer. If the customer has sufficient rewards points, the customer may select the desired offer and may cause the customer terminal 151 to communicate an acceptance message identifying the desired offer. The server 101 may confirm that the customer has sufficient rewards points and, if so, may deduct the rewards points and initiate a transaction for the financial product. If the customer does not yet have sufficient rewards points and instead is setting a goal to redeem an offer, the server 101 may store a flag or other indicator to award bonus rewards points (if applicable) to the customer for the desired offer upon accruing the requisite amount of rewards points.

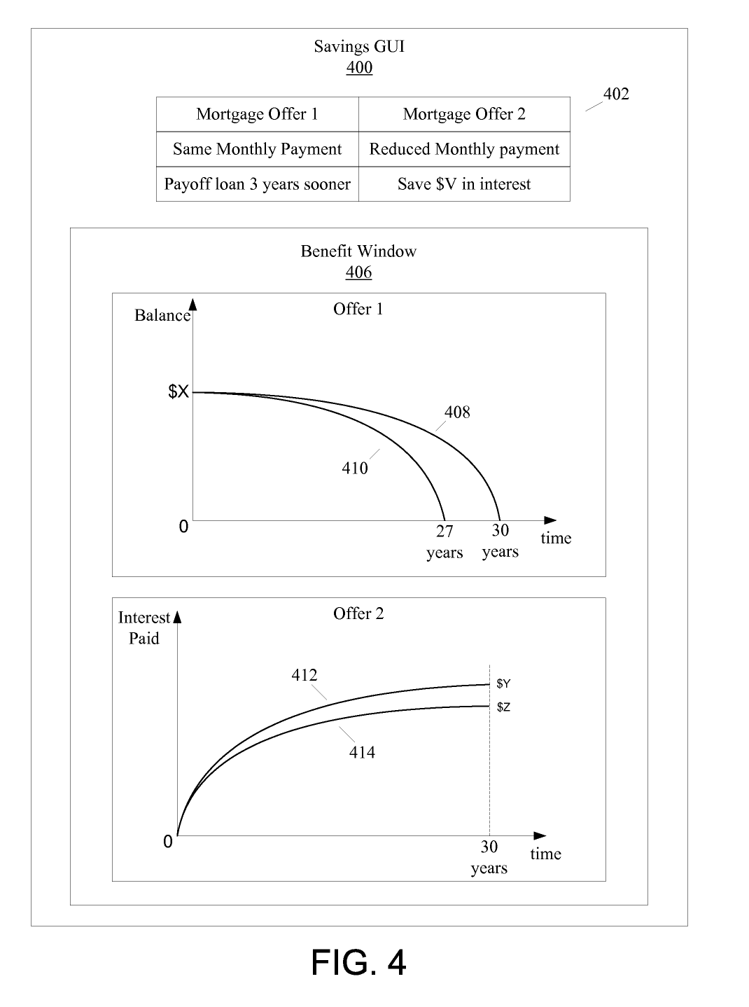

To aid the customer when selecting between offers, the server 101 may also perform calculations to inform the customer of potential savings and/or benefits that may be achieved. FIG. 4 illustrates an example savings GUI 400 presenting potential savings and/or benefits to a customer. In an example, the customer may select an offer for a home mortgage from the offer table 302 and the server 101 may communicate a Savings GUI 400 for display by the customer terminal 151. The Savings GUI 400 may present a calculation indicating potential savings and/or benefits to the customer for the selected offer. In a mortgage example, the Savings GUI 400 may be presented in terms of reducing the length of the loan (e.g., payoff mortgage 3.5 years sooner) and/or interest savings over the length of the loan. For instance, the customer may elect to use rewards points to reduce an APR of the loan, but maintain a same payment amount as if the APR were not reduced. This leads to the customer putting additional money towards principal each month (or other periodic time interval), thereby reducing the length of the loan (particularly if the loan has a fixed interest rate). The customer may also elect to use points to reduce an APR of the loan that results in a periodic payment being lowered over the duration of the loan. Thus, the loan may cover the same amount of time, but the customer's payment may be lower each month (or other periodic time interval).

The savings GUI 400 may include a benefit window 406 graphically depicting the benefit for each of the offers. For mortgage offer 1 (i.e., same payment, lower interest rate), the savings/benefit window 406 includes two curves showing a customer's balance over time. The curve 408 may represent the balance over time should the customer elect not to use points to reduce the APR, and the curve 410 may represent the balance over time where points are used to reduce the APR. As can be seen, both curves 408 and 410 may start with an initial balance of $ X, and the curve 408 may reach a balance of $0 at 30 years and the curve 410 may reach a balance of $0 at 27 years. For mortgage offer 2 (i.e., lower payment, lower interest rate), the savings/benefit window 406 includes two curves showing an amount of interest paid over time. Curve 412 may indicate that $Y in interest is paid over the term of the loan, and Curve 414 may indicate that $Z in interest is paid over the term of the loan, where $Z is less than $Y. The benefit window 406 may permit a customer to visualize the benefit of each offer to make an informed decision. The savings and/or benefits may also show how much a customer could have saved over past time periods.

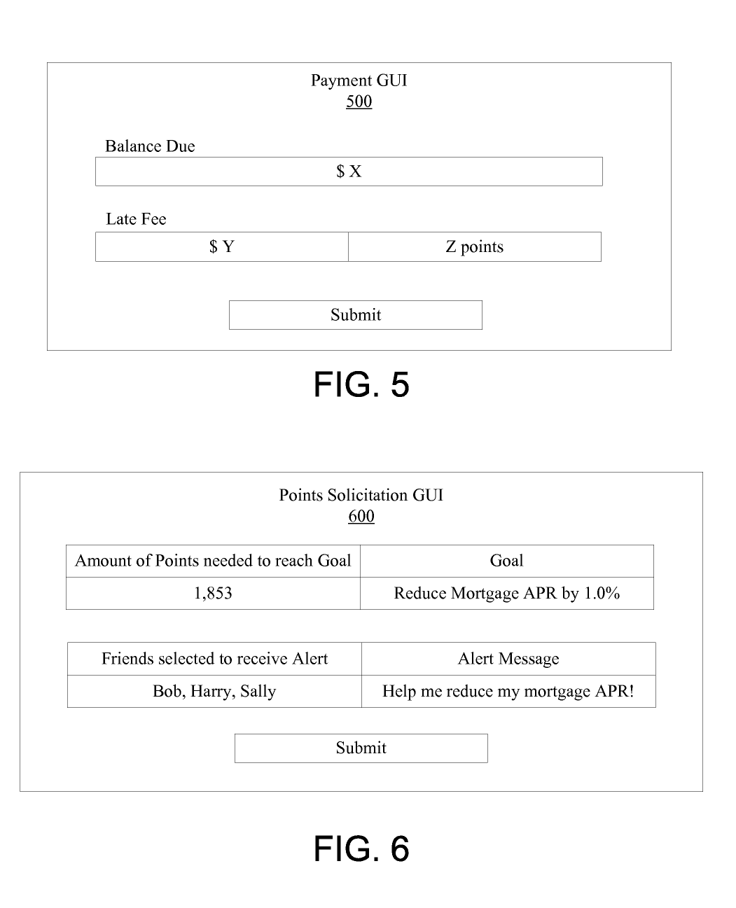

Points may also be used in other manners to benefit the customer. For example, a customer may use points in lieu of cash to pay a fee and/or to obtain a discount. FIG. 5 illustrates a payment GUI 500 for an account where a customer may use points to pay a fee. The account may be a credit card account, a mortgage account, or any other type of account a customer may have. The fee may be a late fee or other type of fee assessed to a customer. The payment GUI 500 may permit the customer to make an electronic payment, where the customer may select whether they wish to pay the fee with cash or points. Points may also be used to reduce a cost per trade on a brokerage account, to cover a penalty for taking money out of a CD before maturity, etc. Generally, the payment GUI 500 or other type of interface may provide the customer with the option to either pay a certain amount (e.g., a fee or cost) or use a predetermined number of points in lieu of a cash payment and/or to obtain a discount.

A customer may also interact with their social network to accrue points to help attain a goal and/or for charitable causes. FIG. 6 illustrates an example points solicitation GUI 600. Customers may collaborate with one another to attain a desired number of points for one member or for all members of a particular social network group.

A customer may reach out to their friends and family, or even complete strangers, to solicit points. Via the points solicitation GUI 600, a customer may identify a group of individuals or organizations to contact, and may input contact information for each member of the group. For example, the customer may input a telephone number, an email address, a screen name, a user name, a postal address, etc. The customer may also input text, video and/or audio to accompany an alert message sent to the group members (e.g., Help me reduce by mortgage APR! Less than 2000 points to go!). The customer terminal 151 may communicate a solicitation message including the contact information and/or the customer input to the server 101. The server 101 may then communicate an alert message via the network 131 (or other manners) for contacting computer terminals 141 (or other devices) of each of the group members. The alert message may also inform the group members of a goal (e.g., reduce mortgage APR) and/or the number of points needed (e.g., 1853 points) to achieve the goal. The customer terminal 151, instead of and/or in addition to the server 101, may communicate the alert message to computer (or other communication devices) of the group members.

The goal may also be a group goal, where the members contribute to a group total of rewards points. Each member of the group may work together to obtain a benefit for all members in the group (e.g., reduce APR for each member's credit card account) and/or for a charitable cause when a group points threshold is achieved. For example, a group of fraternity members could pool points to buy down a mortgage rate for their fraternity house, a group of YMCA members could pool their points to help the local chapter get a better mortgage/lease rate for their property, and the like. A customer may also solicit others to benefit any desired cause.

Each group member may accept or decline to donate points to a particular customer or to a group total. For example, a computing device 141 of a group member (hereinafter group member terminal 141) may receive the alert message and generate a donation message in reply. The donation message may indicate an amount of points being donated (e.g., zero or more) and may also include input (e.g., text, video, and/or audio) to the soliciting customer (e.g., Good luck on reaching your goal!). The group member terminal 141 may communicate the donation message to the customer terminal 151 and/or to the server 101. The server 101 may store (e.g., using a memory, database, etc.) a number of points associated with each customer, and may adjust the points of the soliciting customer and of the donating group member based on the number of points donated.

When members decide to donate to a group goal, the server 101 may establish a group account to store the points donated by the group members. For example, members of a social network group may all want to help one another lower an APR for each of their respective credit card accounts. If the group reaches a certain point total, then the financial institution may lower an APR for all of the members. The group members may sign up to automatically donate all of their rewards points (or accrued after a certain date), a percentage of their rewards points, and/or a one-time or recurring donation of a particular amount of rewards points to the group account. As each group member accrues rewards points, the server 101 may transfer rewards points to the group account from a respective member's personal account. The server 101 may also send out status update alerts at certain milestones (e.g., certain percentages of required number of points to reach goal) to inform group members of how many points are in the group account and how many more are needed.

When soliciting points for charitable causes, the financial institution may match donated points. To do so, the server 101 may store one or more matching rules and may monitor an amount of points accrued in a group account for a charitable cause. Example matching rules may be a first rule where points are matched up to a certain amount, a second rule where a predetermined number of points are added upon reaching a certain points threshold, a third rule may be a points multiplier upon reaching a points threshold, etc. Similar matching rules may be used when awarding bonus points, as discussed above. The server 101 may determine when conditions of a particular rule have been met, and may then award bonus rewards points using an appropriate mathematical function based on identifying a match.

The example embodiments also may permit adjustment of financial term (e.g., interest rate) using other types of collateral. For example, a user's home may be used as collateral to lower an interest rate for a line of credit (e.g., credit card account). A financial institution may be concerned that a customer may borrow funds, and later may be unable to repay the borrowed amount. A credit score is one factor that may be used in assigning an amount of risk associated with a credit card customer, and the riskiness of the customer may be reflected in the interest rate of the credit card account. To mitigate this risk, the financial institution may consider information instead of and/or in addition to a credit score. For example, the financial institution may take a security interest in collateral owned by the customer and use the collateral to adjust a financial term of a financial product/server. Example types of collateral may include cars, homes, art, or other types of valuable assets owned by the customer. In exchange for the security interest, the financial institution may adjust a financial term (e.g., provide a lower interest rate) for a financial service/product of the customer.

Initially, the server 101 may communicate an offer message to the customer terminal 151 regarding an offer to adjust a financial term (e.g., reduce an interest rate) for a financial service/product using collateral. The financial service/product may be an existing account the customer has with the financial institution and/or for opening a new account. The offer message may specify the types of information required to provide proof of ownership of the collateral. For example, proof of ownership may be shown by a clear title to a home, a deed, other instrument, or in other manners. The customer terminal 151 may communicate the requested information to the server 101. The server 101 may verify the proof of ownership by performing, for example, a title search on the collateral.

If the collateral is confirmed to be owned by the customer, the server 101 may determine a value of the collateral and/or if there are any other encumbrances on the collateral (e.g., additional liens). For example, the server 101 may use an online appraisal tool for the collateral (e.g., car or home appraisal) and/or may perform a title search. The server 101 may adjust the value of the collateral determined in the appraisal if any encumbrances are found. The server 101 may communicate a terms message to the customer terminal 151 specifying an offer for an adjusted financial term (e.g., reduced interest rate) if the financial institution is permitted to obtain a security interest (e.g., lien) in the collateral. If unable or unwilling to accept a security interest in the collateral, the server 101 may provide a recommendation of other suitable types of collateral that may be used.

If the customer desires to accept an offer for the adjusted financial term (e.g., a reduced interest rate), the customer may cause the customer terminal 151 to communicate an acceptance message to the server 101 accepting the offer. The server 101 may electronically record or cause to be recorded a security interest in the collateral and, in exchange, may execute a transaction to provide the adjusted financial term (e.g., reduced interest rate) for the financial service/product.

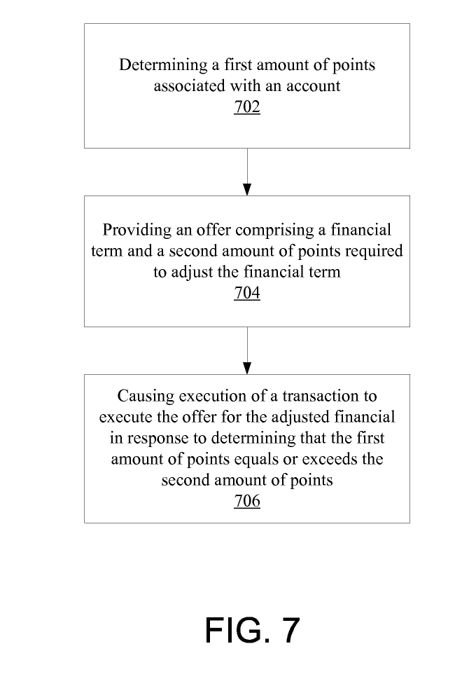

FIG. 7 illustrates an example flow diagram of a method for executing a transaction for an account having an adjusted interest rate in exchange for points in accordance with an example embodiment. The method may be implemented by the server 101 or other computer. The order of the blocks depicted in FIG. 7 may be rearranged, one or more blocks may be repeated in sequential and/or non-sequential order, and/or one or more blocks may be omitted. Further, other blocks may be added to the flow diagram. The method may begin at block 702.

In block 702, the method may include determining a first amount of points associated with an account. For example, the server 101 may process a transaction where a user makes a purchase using a credit card, and may award rewards points associated with a credit card account based on the amount of the purchase. The server 101 may store a total amount of points accrued by the user.

In block 704, the method may include providing an offer comprising a financial term (e.g., an interest rate for a car loan) and a second amount of points required to adjust the financial term (e.g., reduce the interest rate). For example, the offer may be for opening a new account and/or to adjust the interest rate of an existing account. In another example, the server 101 may determine an available offer for a new financial product/service (or an existing account of the customer) based on historical offers that have been accepted by the customer. The offer may identify a current interest rate of the product, as well as a reduced interest rate that the customer may obtain in exchange for a predetermined number of rewards points.

In block 706, the method may include causing execution of a transaction to execute the offer for the adjusted financial term in response to determining that the first amount of points equals or exceeds the second amounts of points. For example, the customer may cause the customer terminal 151 to communicate an acceptance message to the server 101 accepting the offer. The server 101 may determine that the amount of rewards points accrued by the customer equals or exceeds the amount of points required to redeem the offer for the reduced interest rate. If equaling or exceeding, the server 101 may cause execution of a transaction to execute the offer for the adjusted interest rate. The method may then end or return to any of the preceding blocks.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

1. An apparatus comprising:
at least one processor; and
at least one memory storing computer executable instructions that, when executed, cause the apparatus at least to:
determine a first amount of points associated with an account;
provide an offer comprising a financial term and a second amount of points required to adjust the financial term; and
cause execution of a transaction to execute the offer for the adjusted financial term in response to determining that the first amount of points equals or exceeds the second amount of points.

2. The apparatus of claim 1, wherein the providing of the offer comprises:
determining a listing of available offers; and
filtering the listing of available offers to obtain the offer.

3. The apparatus of claim 2, wherein the filtering of the listing is based on a plurality of recent transactions associated with the account.

4. The apparatus of claim 3, wherein the processing of the plurality of recent transactions comprises identifying a financial product and/or service being provided by a competitor.

5. The apparatus of claim 2, wherein the filtering of the listing comprises assigning a user associated with the account to a particular one of a plurality of categories based on demographic information.

6. The apparatus of claim 5, wherein the filtering of the listing comprises determining that other users in the particular category have a financial product and/or service that the user does not.

7. The apparatus of claim 1, wherein the offer comprises an incentive awarding additional points upon reaching a predetermined points level.

8. The apparatus of claim 1, wherein the computer executable instructions, when executed, cause the apparatus to process an acceptance message accepting the offer with the adjusted financial term.

9. The apparatus of claim 1, wherein the computer executable instructions, when executed, cause the apparatus to:
process a solicitation message and an identification of one or more members of a social network; and
communicate an alert message to at least one of the members.

10. The apparatus of claim 9, wherein the computer executable instructions, when executed, cause the apparatus to:
process a donation message identifying a predefined amount of points and a donor; and
update the first amount of points to include the predefined amount of points and reduce a donor amount of points based on the predefined amount of points.

11. The apparatus of claim 1, wherein the determining of the first amount of points comprises:
determining that the first amount of points corresponds to a matching rule; and
adding bonus points to the first amount of points.

12. The apparatus of claim 11, wherein an amount of the bonus points is determined using a mathematical function.

13. The apparatus of claim 11, wherein the matching rule specifies adding a predetermined number of the bonus points upon the first amount of points reaching a threshold.

14. The apparatus of claim 1, wherein the financial term is one of an interest rate, an annual percentage rate, and/or a fee.

15. A method comprising:
determining, by a processor, a first amount of points;
providing an offer comprising a financial term and a second amount of points required to adjust the financial term; and
causing execution of a transaction to execute the offer for the adjusted financial term in response to determining that the first amount of points equals or exceeds the second amount of points.

16. The method of claim 15, wherein the providing of the offer comprises:
determining a listing of available offers; and
filtering the listing of available offers to obtain the offer based on a plurality of recent transactions and on assigning a user to a particular one of a plurality of categories using demographic information.

17. The method of claim 15, wherein the determining of the first amount of points comprises:
determining that the first amount of points corresponds to a matching rule; and
adding bonus points to the first amount of points.

18. A non-transitory computer-readable storage medium storing computer-executable instructions that, when executed, cause an apparatus at least to perform:
determining a first amount of points associated with an account;
providing an offer comprising a financial term and a second amount of points required to adjust the financial term; and
causing execution of a transaction to execute the offer for the adjusted financial term in response to determining that the first amount of points equals or exceeds the second amount of points.

19. The computer-readable storage medium of claim 18, wherein the providing of the offer comprises:
determining a listing of available offers; and
filtering the listing of available offers to obtain the offer based on a plurality of recent transactions associated with the account and on assigning a user associated with the account to a particular one of a plurality of categories using demographic information.

20. The computer-readable storage medium of claim 18, wherein the determining of the first amount of points comprises:
determining that the first amount of points corresponds to a matching rule; and
adding bonus points to the accrued first amount of points.
